(19) United States
(12) Patent Application Publication
(10) Pub. No.: US 2006/0059267 A1
(43) Pub. Date: Mar. 16, 2006

(54) System, method, and device for downloading content using a second transport protocol within a generic content download protocol

(75) Inventors: Guido Cugi, Helsinki (FI); Sami Pippuri, Espoo (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation

(21) Appl. No.: 10/985,604

(22) Filed: Nov. 10, 2004

Related U.S. Application Data
(60) Provisional application No. 60/609,495, filed on Sep. 13, 2004.

(51) Int. Cl. G06F 15/16

(52) U.S. Cl. 709/230

(57) ABSTRACT

Provided are improved systems, methods, and devices for downloading content using a second transport protocol within a generic content download protocol, such as using a FLUTE session to download content within a DLOTA session. The DLOTA download descriptor file can point to a media object which is a FLUTE session descriptor file. The DLOTA session permits the FLUTE session to occur before sending an install notification, or content download notification. This type of binding permits users to receive multicast and broadcast unidirectional content delivery masked by a generic content download protocol. Accordingly, the generic content delivery architecture can provide additional functionality to the underlying transfer protocol, such as dynamic capability check, user confirmation, and content download notification.

### CROSS-REFERENCE TO RELATED APPLICATION

This application claims priority to and the benefit of the filing date of provisional application entitled “System, Method, and Device for Downloading Content Using A Unidirectional Transport Protocol Within A Generic Download Protocol,” assigned Ser. No. 60/609,495 and filed Sep. 13, 2004, which is hereby incorporated by reference.

### FIELD OF THE INVENTION

The present invention relates generally to content download and, more particularly, to systems and methods for downloading content using a second transport protocol within a generic content download protocol.

### BACKGROUND

Various protocols have been developed and used for file transfer between servers and clients. Often, protocols define frameworks which permit use of the protocol in a standard manner for various content and/or specific transfer details. For example, a protocol may permit transfer of different file types in the same manner or permit transfer of one or more file types with different transfer specifications such as transfer speed, cache size, or the like. One such transfer protocol is the Open Mobile Alliance (OMA) over-the-air (OTA) download protocol for generic content download, also referred to as the OMA Download OTA (DLOTA) protocol as described in Generic Content Download Over the Air Specification, Version 1.0, OMA (Feb. 21, 2003), the entire contents of which are incorporated herein by reference and as described in Download Architecture Version 1.0, Proposed Version, OMA (Jun. 25, 2004), the entire contents of which are incorporated herein by reference. DLOTA is an application level download protocol used to reliably deliver various types of content to any device which supports one of the content types. Typically DLOTA is used to transmit “generic content,” referring to any MIME media type, except the JAVA™ JAR media type. Generic content includes such media as MIDI ring tones, wallpapers, and screensavers and such media types as JPEG, GIF, and PNG files. DLOTA is used for a standard content download technology to transmit generic content from a download server to a content handler of a device, such as a mobile terminal. For example, a user of a mobile terminal may identify content to download using a discovery process of a discovery application. The content may be identified on a presentation server, or another server that offers content for download. A download agent of the mobile terminal may initiate a download protocol, such as DLOTA, for the content delivery. The presentation server provides identification of a download server where the download agent can find and download the content. If using the DLOTA protocol, the presentation server will provide a download descriptor file (DD) to the download agent (DA). A download descriptor file, an extensible markup language (XML) file, is used by DLOTA to provide information about the content, the content delivery, and the content download notification. The download agent parses the DD to first perform a dynamic capability check to determine that the media object size and MIME type indicated in the DD are capable of and acceptable for downloading and provide any required user confirmation. The actual transfer of the content is typically an HTTP session from the uniform resource identifier (URI) where the content is stored on a download server to the device. The transfer is handled by the DLOTA protocol layered on top of the HTTP session. The download agent also parses the DD for information related to content download notification, also referred to as a status report or install notification. The content download notification refers to the process by which the device, after downloading the content, sends a message to a server, typically associated with the presentation or download server or other content provider server associated with the downloaded content, to indicate a positive or negative outcome of a download transaction. If a content download notification is required, the downloaded content may not become available for use, viewing, or the like by the mobile terminal until the content download notification is sent by the mobile terminal. DLOTA is particularly useful in ensuring that a device is capable of downloading the content and using the downloaded content and that the device notifies a content provider server of the status of the completed download. DLOTA also provides a standardized, uniform user experience by hiding and enhancing the underlying transport protocol and by enabling services dependent upon the download transaction.

Another protocol which has been developed for file transfer is the File Delivery over Unidirectional Transport (FLUTE) standard of the Reliable Multicast Transport (RMT) group of the Internet Engineering Task Force (IETF) and as described in FLUTE—File Delivery Over Unidirectional Transport, RMT (Jun. 5, 2004), the entire contents of which are incorporated herein by reference. FLUTE is designed for broadcast and multicast content delivery to numerous devices concurrently, either synchronously or asynchronously, rather than transfer protocols which rely upon two-way send-acknowledge schemes. FLUTE is described as a suite of building blocks that combine to form a reliable transport protocol. One of the blocks defines forward error correction (FEC) for the broadcast or multicast. Forward error correction refers to an error control system for data transfer where the receiving device has the capability to detect and correct characters and code blocks that contain less than a predetermined number of symbols in error by adding bits to characters and code blocks using a predetermined algorithm. Other FLUTE blocks define packet formats, payload identifiers, and congestion control. FLUTE may be used by selecting different standard building blocks to define a FLUTE compliant implementation.

The FLUTE standard, however, does not include such functionality, reliability, and consistency features of the DLOTA transfer protocol, such as dynamic capability check, user confirmation, and content download notification.

Accordingly, there is a need in the art for an improved system, method, and device for downloading content which permits the use of a generic content download protocol with a second transfer protocol.

### SUMMARY

In light of the foregoing background, embodiments of the present invention provide improved systems and methods for downloading content using a second transport protocol within a generic content download protocol. The present invention provides a manner in which to bind the DLOTA protocol to an underlying, secondary transfer protocol, such as the FLUTE standard. Although typically layered only on top of HTTP, DLOTA can also be employed to deliver content using underlying, secondary transfer protocols such as the FLUTE protocol. An underlying, secondary transfer protocol refers to a protocol which requires a separate transfer session from the transfer session, typically HTTP, used to retrieve the media object in the DLOTA download descriptor file. Stated another way, the present invention provides an architecture for using a generic content download protocol, such as DLOTA, where the media object download of the generic content download protocol is not the actual content intended to be downloaded but only an intermediate data download which provides information for a second transfer protocol session such as a FLUTE session for downloading the intended content. This additional transfer session layer permits DLOTA to be used to expand the concept of a download session to be more than pointing to a media object or media objects. Instead, the media object can point to another media object or transfer session, such as the DLOTA DD pointing to a media object which is a FLUTE session descriptor file that can be processed to execute a FLUTE session to download the intended content. Thus, the benefits of DLOTA can be extended to additional transfer sessions, such as transfer session according to the FLUTE standard. By marrying the FLUTE protocol with the DLOTA protocol, users can receive multicast and broadcast unidirectional content delivery masked by a generic content download protocol. Accordingly, DLOTA provides a generic content delivery architecture with dynamic capability check, user confirmation, and content download notification for FLUTE content delivery. By binding together the DLOTA protocol and FLUTE standard, a content provider server can receive outcome status of the delivery transaction including the underlying FLUTE content download using content download notification of the downloaded content.

Embodiments of methods for downloading content using a second transport protocol within a generic content download protocol include steps of performing a generic content download protocol session on top of a second transfer protocol session. The generic content download protocol session may include requesting, receiving, and processing a download descriptor file and requesting, receiving, and processing a media object that is pointed to by the download descriptor file. The second transfer protocol session may include initiating the session, receiving the content, and signaling the generic content download session that the second transfer protocol session is complete. The generic content download session may then send notification of the status of the content download. The generic content download protocol session may operate according to DLOTA; and the second transfer protocol session may operate according to a unidirectional transport protocol such as the FLUTE standard.

Further embodiments of methods for downloading content using a second transport protocol within a generic content download protocol include the steps of activating a generic content download protocol download agent for processing a descriptor file and a media object which is a descriptor file for a second transfer protocol, activating a second transport protocol download agent, and downloading content according to the processed media object. Embodiments may further include the step of signaling the status of the content download. The generic content download protocol download agent may operate according to DLOTA; and the second transfer protocol download agent may operate according to a unidirectional transport protocol such as the FLUTE standard.

Embodiments of systems capable of downloading content using a second transport protocol within a generic content download protocol include a client node and at least one server node. The client node includes a first download agent for requesting and receiving a generic content download protocol download descriptor file from a server node. The client node also is able to download content according to a second transfer protocol from the same server node, or a different server, during a second transfer protocol session. When the content is downloaded and the second transfer protocol session is complete, the download agent of the client node can send a content download notification regarding the status of the content download to a server, which may be the same server node, a different server node, or a server node associated with either or both the same or different server nodes. Client nodes of embodiments may further include a second download agent for establishing the second transfer protocol session. The first download agent may initiate or activate the second download agent, and the server node transmitting the content transmits the content to the second download agent.

Embodiments of client devices of the present invention are provided that include a controller, a download agent, and memory. The download agent and memory are communicably coupled to the controller. The download agent operates in accordance with a generic download protocol and a second transfer protocol to download content using the second transfer protocol within the generic download protocol. The memory is capable of storing a generic content download protocol descriptor file, a second transport protocol descriptor file, and downloaded content. Further embodiments of client devices of the present invention include first and second download subagents of the download agents for downloading descriptor files and content, respectively. The first download subagent may operate according to DLOTA protocol, and the second download subagent may operate according to the FLUTE standard.

Embodiments of servers of the present invention are provided that include a controller communicably coupled to a transfer agent and memory. The transfer agent operates in accordance with a generic content download protocol and a second transport protocol. The transfer agent is capable of transmitting a generic content download protocol descriptor file and a second transport protocol descriptor file. The memory is capable of storing and providing for transfer by the transfer agent the generic content download protocol descriptor file, the second transport protocol descriptor file, and the content. Transfer agents may be further capable of transmitting content according to the second transport protocol. A server may further include a services agent for performing back-end administrative tasks associated with downloading content from the server using a generic content download protocol.

These characteristics, as well as additional details, of the present invention are further described herein with reference to these and other embodiments.

### BRIEF DESCRIPTION OF THE DRAWING(S)

Having thus described the invention in general terms, reference will now be made to the accompanying drawings, which are not necessarily drawn to scale, and wherein:

FIG. 1 is a control flow diagram illustrating downloading content using the FLUTE standard within the DLOTA protocol of one embodiment of the present invention;

FIG. 2 is a schematic block diagram of an entity capable of operating as a client device, server, download agent, or transfer agent of an embodiment of the present invention;

FIG. 3 is a schematic block diagram of a system of an embodiment of the present invention; and

FIG. 4 is a schematic block diagram of a mobile station capable of operating in accordance with an embodiment of the present invention.

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

While a primary use of the present invention may be in the field of mobile communications, it will be appreciated from the following description that the invention is also useful for various other types of wireless and wired communications. Further, while a primary use of mobile stations of the present invention may be in the field of mobile phone technology, it will be appreciated from the following that many types of devices that are generally referenced herein as mobile stations, including, for example, mobile phones, pagers, handheld data terminals and personal data assistants (PDAs), portable personal computer (PC) devices, electronic gaming systems, global positioning system (GPS) receivers, satellites, and other portable electronics, including devices that are combinations of the aforementioned devices may be used with the present invention.

The present invention is described herein with particular reference to the DLOTA protocol and the FLUTE standard; however, it will be appreciated from the following description that the invention may be used with other generic content download protocols layered over second transfer protocols according to the communications architecture of the present invention. The term “client device” as used herein refers to any machine or like device which has communication functionality to operate according to an embodiment of the present invention and includes, but is not limited to, mobile stations such as mobile phones and like portable, wireless devices.

The DLOTA protocol can effectively be used as a download framework for a FLUTE session, thereby, providing a user of a client device a consistent user experience through a common DLOTA download interface, regardless of the content and/or transfer protocol ultimately used to download the content. For example, by using DLOTA to download content, a user of a client device need not recognize whether the download occurs using HTTP or the FLUTE standard; the user experience will be the same. Also, by layering the DLOTA protocol over a FLUTE session, the back-end infrastructure of the DLOTA architecture is provided to a download using the FLUTE standard. For example, activities dependent upon the download of content and/or the outcome of the download as indicated by content download notification or like notification message, such as billing, logging, digital rights issuance, and various other services, available using the DLOTA protocol are available where DLOTA is layered over a FLUTE session. Thus, the back-end infrastructure of DLOTA can be used, or re-used, unchanged with the FLUTE standard.

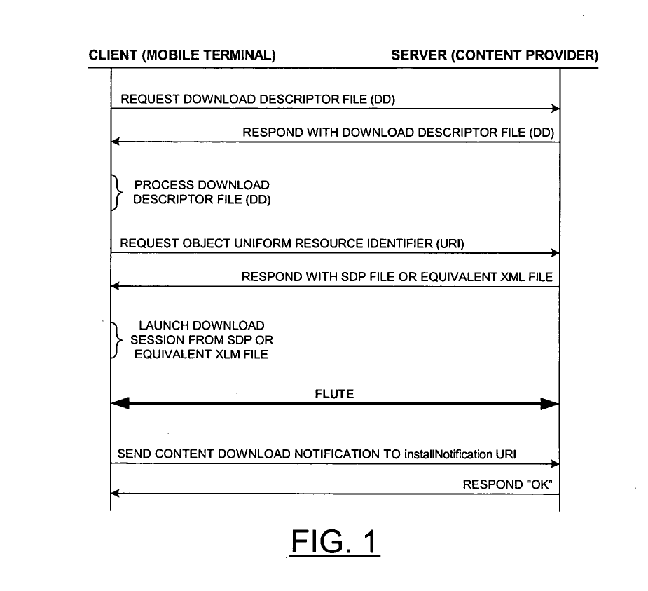

FIG. 1 is a control flow diagram illustrating downloading content using the FLUTE standard within the DLOTA protocol of one embodiment of the present invention. The control flow diagram of FIG. 1 proceeds after a user of a terminal has discovered content for download hosted by a content provider, such as content hosted on a presentation server. One of ordinary skill will recognize and understand various typical and/or standard communications between the described server and client, such as initiation handshakes and authentications, which are not described in the control flow diagram of FIG. 1. For example, a user of a client device may use a discovery application to search and identify content for downloading.

The control flow diagram begins with a client device, such as a mobile terminal, requesting a download descriptor file (DD) for content intended for downloading. The request may be initiated, for example, by a user of a client device selecting a link intended to download content. In response, a content provider server, or like server, sends the requested DD referring to and providing information about the specific media object. The DD is delivered to the client device before the content, such as a media object, is actually downloaded from the content provider server. The client, or, more specifically, typically a download agent (DA) executed by the client processes the DD to ensure that the client can and should proceed with the content download. For example, the client verifies that the client has available content storage, or memory, at least as large as the size of the content for downloading as indicated in the DD. Further, the client verifies that the client is capable of using the media type of the content for downloading. Also provided in the DD is the uniform resource identifier (URI or like reference from where the content can be downloaded. If the client determines to proceed with the download, the client requests the media object at the URI, such as issuing an HTTP GET command to the URI specified in the objectURI attribute of the DD. In the case where the DLOTA protocol is layered over a FLUTE session, the server responds to the URI request by sending a FLUTE trigger file, the Session Description Protocol (SDP) or equivalent XML file, to the client for the FLUTE session. Thus, the objectURI of the DD actually points to a media object which is a FLUTE session descriptor file and not the intended content to be downloaded. The SDP or equivalent XML file is processed and used by the client to trigger and perform the FLUTE session. For example, when the client receives the FLUTE SDP or equivalent XML file, the client may launch a FLUTE download agent to execute a FLUTE download session according to the parameters specified in the SDP or equivalent XML file. For example, a FLUTE SDP may include parameters for the sender IP address, the number of channels in the FLUTE session, the destination IP address and port number for each channel in the FLUTE session, the Transport Session Identifier (TSI) of the FLUTE session, the content URI, and the media type(s) of the file(s) being transmitted during the FLUTE session. The FLUTE download session may begin automatically, such as by setting an installParameter attribute of the DD file to < . . . > to indicate to the client to execute the SDP or equivalent XML file to start the FLUTE download session and/or to indicate to the client that the download of the media object, the SDP or equivalent XML file, from the URI of the objectURI attribute in the DD does not end the DLOTA session, but that the DLOTA session should remain open until the FLUTE session downloads the intended content. The < . . . > represents some type of data which is recognized as indicating, in some manner or for some action, to the DLOTA DA that there is an underlying download session, such as the FLUTE session, still operating as part of the download transaction. The client initiates the FLUTE session to download the intended content; the content is saved to the client device; and the FLUTE session is closed. An indication may be provided to the client when the FLUTE session is complete, such as a message from the FLUTE download agent to the DLOTA download agent, so the client, using information provided in the DD, will then send a content download notification to a content provider server. For example, the DD may indicate a URI in the installNotificationURI attribute to which the client should send the content download notification. The server may respond with an acknowledgement, such as by sending an “OK” message to the client. The DLOTA content download notification refers to the download of the media object carried by the FLUTE session instead of the SDP or equivalent XML file.

The download agent (DA) of the client device is responsible for both the DLOTA protocol and the FLUTE session, or is responsible for the DLOTA protocol and at least closely coupled to an agent responsible for running the FLUTE session. The DA is able to receive and process the DD for the DLOTA. And, if responsible for the FLUTE session, the DA also runs the FLUTE session. Thus, a single DA can be used for the entire download transaction, or an additional DA may be used for the FLUTE session. For example, because the DLOTA protocol operates at the application level and the FLUTE standard operates at the transport level, separate download agents for the overall DLOTA session and the underlying FLUTE session may provide a simpler, more manageable implementation of the architecture of the present invention. However, in general, one DA is controlling the download transaction and may or may not rely upon other download agents to perform the download transaction.

The download descriptor file (DD) for a DLOTA protocol layered FLUTE session typically includes the following attributes: type, description, size, name, vendor, iconURI, infoURL, objectURI, and installNotifyURI. The type attribute indicates the MIME type(s) of the media object(s) to be downloaded using a FLUTE session as well as any other MIME type(s) required during the download transaction, such as the SDP or equivalent XML file for the FLUTE session. The description, size, name, vendor, iconURI, and infoURL attributes all provide information about the content which is being downloaded by the FLUTE session, such as a description of the content (description attribute), the size in bytes of the media object file(s) to be downloaded (size attribute), a user readable name of the content and/or media object file(s) (name attribute), a URI reference where an icon for the content can be downloaded (iconURI attribute), and a uniform resource locator (URL) for additional information about the content and/or media object file(s) (infoURL attribute). The objectURI attribute of the DD points to URI (or URL) for the SDP or equivalent XML file for the FLUTE session such as a file that triggers the FLUTE session at the client device or a descriptor file for the FLUTE session. The installNotifyURI attribute points to the back-end service URI at the content provider server or an associated server where the client device should send the content download notification message once the content has been downloaded by the FLUTE session. Status report codes for the content download notification message are defined by DLOTA. Additional status report codes that are specific to the FLUTE session can be added to the DLOTA protocol and used when the DLOTA protocol is layered over the FLUTE standard. Other attributes may be included in the DD according to the OMA DLOTA protocol, including, but not limited to, the nextURL and version DLOTA attributes. For example, an installParameter attribute may be set to < . . . > to force the client to execute the SDP or equivalent XML file to start the FLUTE session and/or to notify the DLOTA download agent not to close the DLOTA session but to wait for the FLUTE content to download because the media object downloaded is not the content but only a FLUTE session descriptor. Some attribute or similar action should identify to the DLOTA download agent that there is an underlying transport protocol session which needs to occur before closing the DLOTA session. Alternatively, a DD attribute, such as the installParameter attribute, may provide the FLUTE session descriptor information for executing the FLUTE session to download the content, thereby precluding the need to download a separate FLUTE session descriptor file, such as an SDP or equivalent XML file.

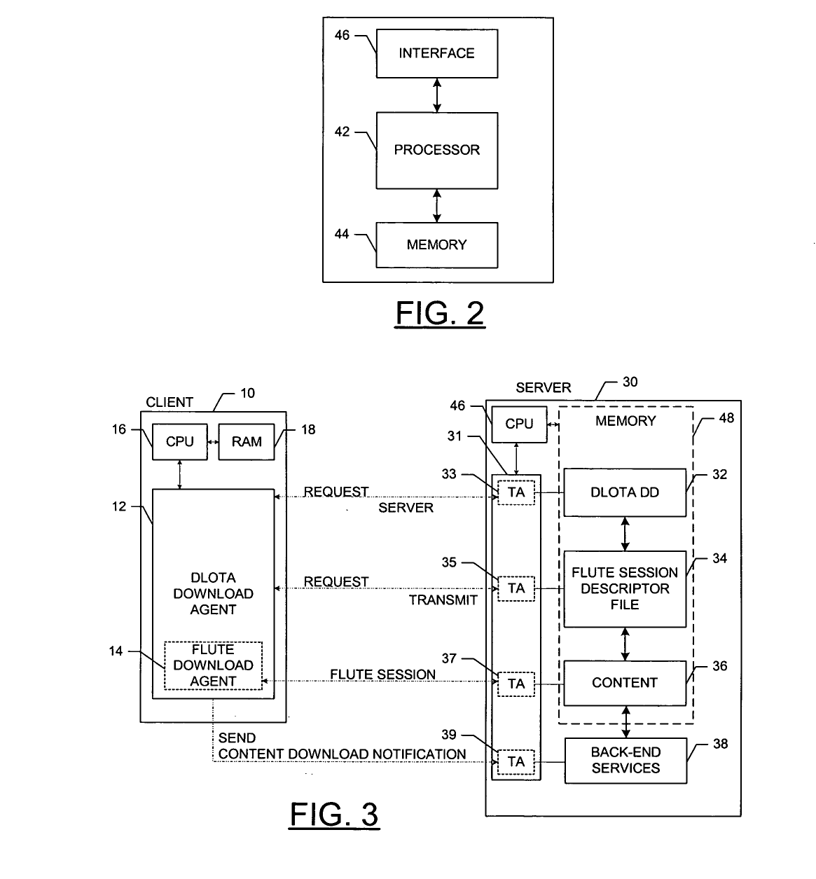

Reference is now made to FIG. 2, which illustrates a block diagram of an entity capable of downloading content using a second transport protocol within a generic content download protocol of an embodiment of the present invention, such as a client 10 or a server 30 of FIG. 3. As shown, the entity capable of downloading content using a second transport protocol within a generic content download protocol generally includes a processor, controller, or the like 42 connected to memory 44. The memory 44 can include volatile and/or non-volatile memory and typically stores content, data, or the like. For example, the memory 44 typically stores computer program code such as software applications or operating systems, information, data, content, or the like for the processor 42 to perform steps associated with operation of the entity in accordance with embodiments of the present invention. Also, for example, the memory 44 typically stores content transmitted from, or received by, the network node. Memory 44 may be, for example, random access memory (RAM), a hard drive, or other fixed data memory or storage device. Where the entity provides wireless communication, the processor 42 may operate with a wireless communication subsystem (not shown), such as a cellular transceiver. The entity may further include at least one interface 46, such as a network interface, a radio transceiver, or other means for transmitting and/or receiving data, content or the like. The interface 46 may be connected to the processor 42. One or more processors, memory, storage devices, and other computer elements may be used in common by a computer system and subsystems, as part of the same platform, or processors may be distributed between a computer system and subsystems, as parts of multiple platforms.

FIG. 3 is a schematic block diagram of a system of an embodiment of the present invention. A client device 10 is shown communicating with a server 30. The client device 10, such as a mobile phone, includes a download agent (DA) 12 responsible for the DLOTA session, and possibly also directly responsible for the FLUTE session. Alternatively, a separate FLUTE download agent (DA) 14 may be employed by the DLOTA download agent (DA) 12 to execute the FLUTE session. The client device 10 includes a controller, such as a central processing unit (CPU) 16 or similar processor, and memory, such as random access memory (RAM) 18 or similar memory or storage. The CPU 16 performs the operations required for the download agent (DA) 12 and stores in and/or retrieves data from the memory 18. The server 30, such as a content provider server, includes a DLOTA descriptor file 32, a FLUTE session descriptor file 34, and the content 36. The server 30 also includes a back-end services application 38, such as to perform billing and like functions related to the download of the content 36. Although shown as a single server 30, it is to be understood as described herein that more than one server may be used for the presentation and linking of content for download, providing the DLOTA DD, providing the FLUTE session descriptor file, providing the content, and receiving the content download notification from the client. Accordingly, each server in a content provider system may include a transfer agent 33, 35, 37, 39 for communicating with a client device. Although, as shown for the single server 30 in FIG. 3, a single transfer agent 31 may be used to communicate with the client device. The server 30 includes a controller, such as a central processing unit (CPU) 46 or similar processor, and memory 48, such as random access memory (RAM), a hard drive, or similar memory or storage device(s). The CPU 16 performs the operations required for the download agent (DA) 12 and stores data in and/or retrieves data from the memory 18. For example, the DLOTA DD 32, the FLUTE session descriptor file 34, and the content 36 may all be stored in and retrieved from the memory 48.

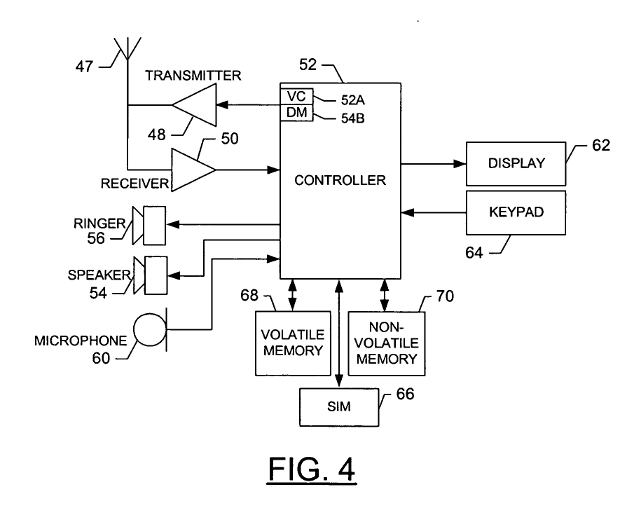

FIG. 4 illustrates a functional diagram of a mobile device, or mobile terminal or mobile station (MS), capable of downloading content using a second transport protocol within a generic content download protocol of an embodiment of the present invention. The mobile device shown in FIG. 4 is a more detailed depiction of one version of an entity shown in FIG. 2, both of which may be a client 10 of FIG. 3. It should be understood, that the mobile device illustrated and hereinafter described is merely illustrative of one type of mobile station that would benefit from the present invention and, therefore, should not be taken to limit the scope of the present invention or the type of devices which may operate in accordance with the present invention. While several embodiments of the mobile device are hereinafter described for purposes of example, other types of mobile stations, such as portable digital assistants (PDAs), pagers, laptop computers, and other types of voice and text communications systems, can readily be employed to function with the present invention.

The mobile device includes an antenna 47, a transmitter 48, a receiver 50, and a controller 52 that provides signals to and receives signals from the transmitter 48 and receiver 50, respectively. These signals include signaling information in accordance with the air interface standard of the applicable cellular system and also user speech and/or user generated data. In this regard, the mobile device can be capable of operating with one or more air interface standards, communication protocols, modulation types, and access types. More particularly, the mobile device can be capable of operating in accordance with any of a number of second-generation (2G), 2.5G and/or third-generation (3G) communication protocols or the like.

It is understood that the controller 52, such as a processor or the like, includes the circuitry required for implementing the video, audio, and logic functions of the mobile device. For example, the controller may be comprised of a digital signal processor device, a microprocessor device, and various analog to digital converters, digital to analog converters, and other support circuits. The control and signal processing functions of the mobile device are allocated between these devices according to their respective capabilities. The controller 52 thus also includes the functionality to convolutionally encode and interleave message and data prior to modulation and transmission. The controller 52 can additionally include an internal voice coder (VC) 52A, and may include an internal data modem (DM) 52B. Further, the controller 52 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile device may also comprise a user interface such as including a conventional earphone or speaker 54, a ringer 56, a microphone 60, a display 62, all of which are coupled to the controller 52. The user input interface, which allows the mobile device to receive data, can comprise any of a number of devices allowing the mobile device to receive data, such as a keypad 64, a touch display (not shown), a microphone 60, or other input device. In embodiments including a keypad, the keypad can include the conventional numeric (0-9) and related keys (#, *), and other keys used for operating the mobile device and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile device can also include memory, such as a subscriber identity module (SIM) 66, a removable user identity module (R-UIM) (not shown), or the like, which typically stores information elements related to a mobile subscriber. In addition to the SIM, the mobile device can include other memory. In this regard, the mobile device can include volatile memory 68, as well as other non-volatile memory 70, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile device. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application, such as a software program or modules for an application, such as to implement downloading content using a second transport protocol within a generic content download protocol of an embodiment of the present invention, and may store an update for computer program code for the mobile device.

One of ordinary skill in the art will recognize that the present invention may be incorporated into hardware and software systems and subsystems, combinations of hardware systems and subsystems and software systems and subsystems, and incorporated into network systems and mobile stations thereof. In each of these systems and mobile stations, as well as other systems capable of using a system or performing a method of the present invention as described above, the system and mobile station generally may include a computer system including one or more processors that are capable of operating under software control to provide the techniques described above, including downloading content using a second transport protocol within a generic content download protocol.

Computer program instructions for software control for embodiments of the present invention may be loaded onto a computer or other programmable apparatus to produce a machine, such that the instructions which execute on the computer or other programmable apparatus create means for implementing the functions described herein, such as a mobile station employing the DLOTA protocol for a FLUTE sessions. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions described herein, such as a method for downloading content using a second transport protocol within a generic content download protocol. It will also be understood that each block or element, and combinations of blocks and/or elements, can be implemented by hardware-based computer systems, software computer program instructions, or combinations of hardware and software which perform the specified functions or steps of downloading content using a second transport protocol within a generic content download protocol.

The present invention may be specified, for example, in the OMA Download OTA Version 2.0, or as an extension of the OMA Download OTA Version 1.0 or 2.0, and in the FLUTE standard, or as an extension of the FLUTE standard. However, embodiments of the present invention are not limited to the use of a FLUTE session to download content within a DLOTA session, and, instead, may be employed to download content using any one of various second transport protocols within some different generic content download protocol.

Herein provided and described are improved systems and methods for downloading content using a second transport protocol within a generic content download protocol, such as using a FLUTE session to download content within a DLOTA session. A DLOTA download descriptor file of an embodiment of the present invention can point to a media object which is a FLUTE session descriptor file. The DLOTA session permits the FLUTE session to occur before sending an install notification, or content download notification. This type of binding permits users to receive multicast and broadcast unidirectional content delivery masked by a generic content download protocol in accordance with embodiments of the present invention. Accordingly, the generic content delivery architecture of the present invention can provide additional functionality to the underlying transfer protocol, such as dynamic capability check, user confirmation, and content download notification.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of downloading content using a second transport protocol within a generic content download protocol, comprising the steps of:
obtaining information identifying a downloadable media object during a generic content download protocol session;
processing the media object to identify a second transport protocol session for downloading the content; and
downloading the content during the second transport protocol session.

2. The method of claim 1, further comprising the steps of:
initiating the generic content download protocol session to download content;
requesting a download descriptor file for the generic content download protocol session; and
processing the download descriptor file to identify the media object.

3. The method of claim 1, further comprising the step of preserving the generic download protocol session active while downloading the content during the second transport protocol session.

4. The method of claim 1, further comprising the steps of:
requesting the media object following its identification; and
receiving the media object.

5. The method of claim 1, further comprising the step of sending a content download notification for the generic content download protocol session following download of the content using the second transport protocol session.

6. The method of claim 5, further comprising the step of signaling the generic content download protocol session when the content is successfully downloaded using the second transport protocol session.

7. The method of claim 1, wherein the generic content download protocol session operates according to the OMA Download OTA (DLOTA) protocol.

8. The method of claim 1, wherein the second transport protocol session operates according to a unidirectional transport protocol.

9. The method of claim 8, wherein the unidirectional transport protocol session operates according to the File Delivery over Unidirectional Transport (FLUTE) standard.

10. A method of downloading content using a second transport protocol within a generic content download protocol, comprising the steps of:
activating a generic content download protocol download agent for downloading and processing a generic content download protocol session descriptor file;
processing a generic content download protocol session descriptor file to identify a media object for download;
processing the media object downloaded using the generic content download protocol download agent;
activating a second transport protocol download agent according to the processed media object for executing a second transport protocol session;
executing a second transport protocol session according to the processed media object; and
downloading content using the second transport protocol session.

11. The method of claim 10, further comprising the step of signaling the status of the content download.

12. The method of claim 10, wherein the generic content download protocol download agent operates according to the OMA Download OTA (DLOTA) protocol.

13. The method of claim 10, wherein the second transport protocol download agent operates according to a unidirectional transport protocol.

14. The method of claim 10, wherein the second transport protocol download agent operates according to the File Delivery over Unidirectional Transport (FLUTE) standard.

15. A system capable of downloading content using a second transport protocol within a generic content download protocol, comprising:
a client node, comprising a first download agent capable of obtaining information identifying a downloadable media object during a generic content download protocol session and processing the media object to identify a second transport protocol session for downloading content; and
at least one server node, communicably connected to said client node, and wherein at least a first server node is communicably coupled to said first download agent of said client node and capable of transmitting the information identifying a downloadable media object.

16. The system of claim 15, wherein said first download agent is further capable of requesting and receiving a generic content download protocol descriptor file and activating a second transfer protocol session for downloading content.

17. The system of claim 16, wherein said first server node is further capable of transmitting the generic content download protocol descriptor file to said first download agent in response to a request by said first download agent for said generic content download protocol descriptor file.

18. The system of claim 15, wherein said first download agent is further capable of sending a content download notification following download of content.

19. The system of claim 15, wherein said first server node is further capable of activating the second transfer protocol session.

20. The system of claim 15, wherein said client node further comprises a second download agent for establishing the second transfer protocol session with one of said server nodes for downloading content during the second transport protocol session, wherein said first download agent activates said second download agent to activate the second transfer protocol session, and wherein said respective server node transmits the content to said second download agent of said client node.

21. The system of claim 15, comprising at least two server nodes, wherein a second server node is capable of transmitting content according to a second transfer protocol, establishing a transfer session with said client node according to the second transfer protocol, and transferring the content to said client node using the second transfer protocol session.

22. The system of claim 21, wherein said client node further comprises a second download agent for establishing the second transfer protocol session within said second server node, and wherein said second server node transmits the content to said second download agent of said client node.

23. A client device, comprising:
a controller for processing the download of content using a second transport protocol within a generic content download protocol;
a download agent operating in accordance with the generic content download protocol and the second transport protocol communicably coupled to said controller; and
memory, communicably coupled to said controller, capable of storing a generic content download protocol descriptor file, a second transport protocol descriptor file, and downloaded content provided by said download agent to said memory.

24. The client device of claim 23, wherein said download agent comprises a first download subagent operating in accordance with the generic content download protocol and a second download subagent operating in accordance with the second transport protocol, and wherein said first download subagent is capable of obtaining the generic content download protocol descriptor file and the second transport protocol descriptor file and said second download subagent is capable of obtaining the downloaded content.

25. The client device of claim 23, wherein said download agent operates according to the OMA Download OTA (DLOTA) protocol.

26. The client device of claim 23, wherein said download agent operates according to the File Delivery over Unidirectional Transport (FLUTE) standard.

27. A server, comprising:
a controller capable of transmitting content using a second transport protocol within a generic content download protocol;
a transfer agent operating in accordance with the generic content download protocol and the second transport protocol communicably coupled to said controller, wherein said transfer agent is capable of transmitting a generic content download protocol descriptor file and a second transport protocol descriptor file; and
memory, communicably coupled to said controller, capable of storing and providing to said transfer agent the generic content download protocol descriptor file, the second transport protocol descriptor file, and the content.

28. The server of claim 27, wherein said transfer agent is further capable of transmitting content according to the second transport protocol.

29. The server of claim 27, further comprising a services agent for performing administrative tasks related to downloading content from said server using a generic content download protocol.

30. The server of claim 27, wherein said memory comprises a generic content download protocol descriptor file.

31. The server of claim 30, wherein said memory comprises a second transport protocol descriptor file.
